(19) United States
(12) Patent Application Publication
(10) Pub. No.: US 2017/0274789 A1
(43) Pub. Date: Sep. 28, 2017

(54) CHARGING PILE CONTROL SYSTEM, MULTI-FUNCTIONAL CHARGING PILE AND ELECTRIC VEHICLE

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Cuilin MA, Beijing (CN)

(21) Appl. No.: 15/241,657

(22) Filed: Aug. 19, 2016

Related U.S. Application Data
(63) Continuation of application No. PCT/CN2016/088661, filed on Jul. 5, 2016.

(30) Foreign Application Priority Data
Mar. 25, 2016 (CN) 2016101768826

(51) Int. Cl. B60L 11/18; G06K 9/00; H04N 7/18

(52) U.S. Cl. CPC B60L 11/1833; B60L 11/1829; B60L 11/182; B60L 11/1846; H04N 7/183; G06K 9/00771

(57) ABSTRACT

The present disclosure relates to a charging pile control system which comprises at least one video monitoring device configured to collect images or video data in a monitoring scope, parse the collected images or video data, and transmit the parsed images or video data to a multi-functional charging pile, the monitoring scope covering at least one parking space and its surrounding area; and a multi-functional charging pile configured to receive the images or video data transmitted by the at least one video monitoring device, analyze according to the images or video data to obtain a position of an electric vehicle entering the monitoring scope relative to an idle parking space among the at least one parking space, and controls the electric vehicle to implement automatic parking. The present disclosure further relates to relevant multi-functional charging pile and electric vehicle.

### CROSS REFERENCE

The present application is a continuation of PCT application which has an application number of PCT/CN2016/088661PCT and was filed on Jul. 5, 2016. This disclosure is based upon and claims priority to Chinese Patent Disclosure NO.201610176882.6, titled “charging pile system, multi-functional charging pile and electric vehicle”, filed on Mar. 25, 2016 with the Chinese Patent Office, the entire contents of which are incorporated herein by reference.

### TECHNICAL FIELD

Embodiments of the present disclosure relate to the technical field of electronic technology and more specifically to a charging pile control system, a multi-functional charging pile and a relevant electric vehicle.

### BACKGROUND

In the process of implement this application, the inventor found at least the following problems in related technologies: as the state supports new energy vehicles, charging facilities are required to prevail in residences to be built in the future. However, the vehicle industry also develops towards more new technologies, such as the Internet of vehicles, automated driving and the like. Currently, depending on the difference of the capacity of a battery configured for the electric vehicle, the vehicle battery usually needs to be charged full in several hours, about 3-8 hours, which seriously limits the development of electric vehicles. Hence, a current proposal is to install a charging pile in a parking lot or beside a standard parking space of residences so that the vehicle may be charged during the parking duration such as at night.

The current charging pile is limited to functions such as charging the vehicle, charging and metering. For example, during the charging, the charging pile may display status information such as charging voltage, charging electrical current, and charging quantity, identify the user's identity, and allow the user to query for information such as a charging card account and balance in the account. However, these functions are all about the vehicle battery charging.

### SUMMARY

One of objectives of embodiments of the present disclosure is to enrich functions of the charging pile, or construct a charging pile-based smart control system.

According to an aspect of the present disclosure, there is provided a charging pile control system. The charging pile control system comprises: at least one video monitoring device is configured to collect images or video data within a monitoring scope, parse the collected images or video data, and transmit the parsed images or video data to a multi-functional charging pile, the monitoring scope covering at least one parking space and its surrounding area; and a multi-functional charging pile configured to receive the images or video data transmitted by the at least one video monitoring device, analyze images according to the images or video data a position of an electric vehicle entering the monitoring scope relative to an idle parking space among the at least one parking space, and control the electric vehicle to implement automatic parking.

Furthermore, the charging pile control system further comprises: at least one smart ground lock disposed in association with the at least one parking space and configured to control an access state of the at least one parking space. The multi-functional charging pile is further configured to control to open a smart ground lock in association with the idle parking space among the at least one smart ground lock when the electric vehicle is controlled to implement automatic parking.

In an embodiment, the multi-functional charging pile is further configured to authenticate the vehicle entering the monitoring scope by using information of the vehicle entering the monitoring scope parsed by the at least one video monitoring device. Controlling the electric vehicle to implement automatic parking comprises only controlling the vehicle that has already passed authentication to implement automatic parking.

In an embodiment, authenticating the vehicle entering the monitoring scope comprises using license plate number and/or vehicle model information among the parsed vehicle information to authenticate the vehicle.

In an embodiment, the using the parsed license plate number and/or vehicle model information to authenticate the vehicle comprises: identifying the vehicle in respect of one or more of the following items: whether the vehicle is an already-registered vehicle, whether the vehicle is an electric vehicle, whether the vehicle supports active parking, and whether the vehicle supports wireless charging.

Furthermore, at least one parking space is provided with at least one wireless charging system. The multi-functional charging pile is further configured to control wireless charging for the electric vehicle which has implemented automatic parking.

According to another aspect of the present disclosure, there is provided a multi-functional charging pile. The multi-functional charging pile may comprise an automatic parking means configured to analyze a position of the electric vehicle relative to the parking space according to the collected images or video data of the electric vehicle and parking space, and control the electric vehicle to implement automatic parking.

Furthermore, the multi-functional charging pile further comprises: a video collecting means configured to collect images or video data within a monitoring scope; and/or a video parsing means configured to parse the images or video data collected by the video collecting means.

Furthermore, the multi-functional charging pile may further comprise: a vehicle authentication means configured to authenticate the vehicle entering the monitoring scope by using information of the vehicle entering the monitoring scope parsed by the at least one video monitoring device. Controlling the electric vehicle to implement automatic parking comprises only controlling the vehicle that has already passed authentication to implement automatic parking.

Furthermore, the multi-functional charging pile may further comprise: a ground lock control means configured to control an access state of the parking space.

Furthermore, the multi-functional charging pile may further comprise: a wireless charging control means configured to control wireless charging for the electric vehicle which has implemented automatic parking.

According to a further aspect of the present disclosure, there is provided an electric vehicle. The electric vehicle may comprise: a parking control means configured to control a power system and a steering system of the electric vehicle to implement automatic parking; and a wireless communication means configured to receive an automatic parking instruction transmitted by the automatic parking means at external of the electric vehicle, and transmit the automatic parking instruction to the parking control means.

In an embodiment, the automatic parking means at external of the electric vehicle is the automatic parking means included by the above-mentioned multi-functional charging pile.

Through various embodiments of the present disclosure, the functions of the electric vehicle charging pile are enriched, a multi-functional charging pile-based smart control system is constructed on the basis of the charging pile, and the user's experience for the charging pile is improved. The charging pile serves as the most important link in industry layout of new energy vehicles. According to embodiments of the present disclosure, the charging pile can be enabled to promote other development directions of the vehicle industry and conduce to spread of the charging pile and new energy vehicles.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 illustrates a schematic view of a charging pile-based charging pile controlling system according to an embodiment of the present disclosure;

FIG. 2 illustrates a function block diagram of a charging pile according to an embodiment of the present disclosure;

FIG. 3 illustrates a flow chart of a charging pile controlling automatic parking of an electric vehicle according to an embodiment of the present disclosure;

FIG. 4 illustrates a schematic view of functions implemented by units of the charging pile as shown in FIG. 2;

FIG. 5 illustrates a function block diagram of an electric vehicle used in cooperation with the charging pile as shown in FIG. 2 according to an embodiment of the present disclosure;

FIG. 6 illustrates a control flow chart of a charging pile authenticating an electric vehicle parked in a parking space according to an embodiment of the present disclosure.

### DETAILED DESCRIPTION

Exemplary embodiments of the present disclosure will be described in more detail below with reference to figures. Although the figures show exemplary embodiments of the present disclosure, it should be appreciated that the present disclosure may be implemented in various forms and should not be limited by embodiments illustrated here. On the contrary, these embodiments are provided to enable more thorough understanding of the present disclosure, and completely convey the scope of the present disclosure to those skilled in the art.

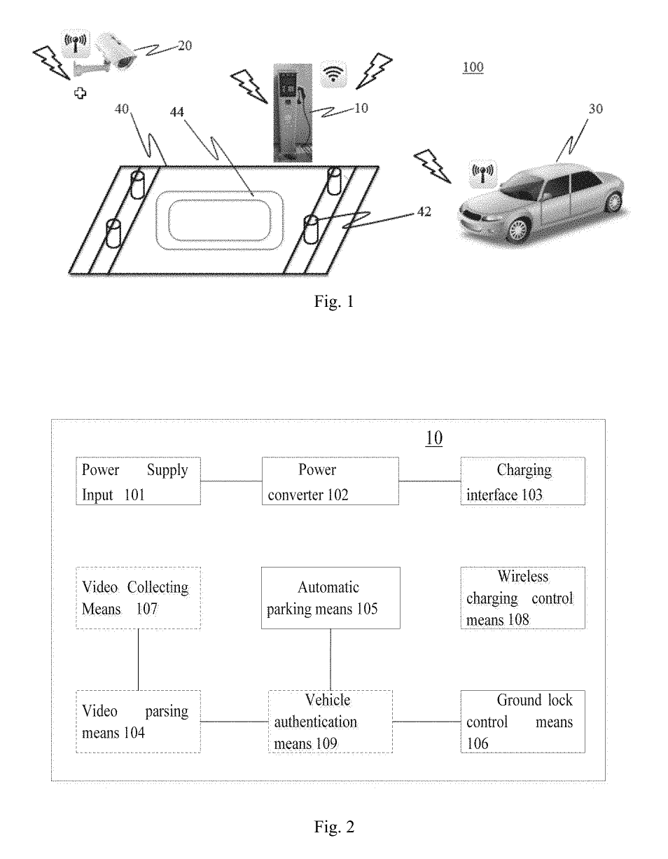

First referring to FIG. 1, it illustrates a schematic view of a charging pile 10-based charging pile controlling system 100 according to an embodiment of the present disclosure. As shown in FIG. 1, the system 100 may comprise a charging pile 10, a video monitoring device 20 and a parking lot 40, the system 100 may further comprise an electric vehicle 30 entering a monitoring scope of the video monitoring device 20. The parking lot 40 may comprises at least one parking space 44, and smart ground locks 42 disposed at a periphery of the parking space. FIG. 1 further shows wireless data links for wireless communications between the charging pile 10, the video monitoring device 20, the electric vehicle 20 and the smart ground locks 42.

The wireless data links in FIG. 1 may employ any wireless connection manner such as remote wireless connection or short-range wireless connection, for example, WLAN 802.11 technology. Networking forms between entities shown in FIG. 1 include but are not limited to the Internet, mobile phone network, wireless area network (LAN), Ad Hoc Network, Ethernet LAN, token-ring LAN, wide area network, and any combinations of these network forms. Communication technologies or communication standard applicable for communication between the respective entities may include but not limited to Code Division Multiple Access (CDMA), Global System for Mobile communication (GSM), universal mobile telecommunications service (UMTS), Time Division Multiple Address (TDMA), Frequency Division Multiple Address (FDMA), Transmission Control Protocol/Internet Protocol (TCP/IP), Short Messaging Service (SMS), Multimedia Messaging Service (MMS), electronic mails, Instant Messaging Service (IMS), Blue-tooth, IEEE 802.11 and the like. Alternatively, communication between partial entities, for example, communication between the charging pile 10 and the video monitoring device 20, or between the charging pile 10 and the smart ground locks 42, may also employ a wired cable.

The system 100 shown in FIG. 1 may be arranged at a residence area, a common parking lot or any proper place. The video monitoring device 20 may be disposed around the parking lot 40 so that the monitoring scope of the video monitoring device 20 can cover the parking lot 40 and its peripheral region so that the video monitoring device can monitor the electric vehicle reaching the periphery of the parking lot.

FIG. 1 only illustrates a situation in which one video monitoring device 20 monitors a parking lot 40, the parking lot 40 comprises a parking space 44, and the charging pile 10 serves the parking lot or parking space. It should be appreciated that the smart control system 100 shown in FIG. 1 is only for exemplary and illustrative purpose, not to limit the present disclosure. For example, the charging pile 10 may serve a plurality of parking spaces of one parking lot 40, or may serve a plurality of parking lots 40; the video monitoring device 20 may monitor a plurality of parking spaces 44 of the parking lot 40, or a plurality of video monitoring devices 20 may be used to monitor the whole parking lot. As such, the plurality of video monitoring devices 20 may serve one charging pile 10. In addition, the number and arrangement manner of the smart ground locks 42 are also exemplary.

In an embodiment, the video monitoring device 20 performs video data acquisition for the vehicle 30 entering the monitoring scope, and transmits the collected video data to the smart charging pile 10. In another embodiment, the video monitoring device 20 may perform video data acquisition and parsing for the vehicle 30 entering the monitoring scope, and transmit video data of the vehicle which is already subjected to parsing and satisfies specific conditions to the smart charging pile 10. It should be appreciated that although in the system 100 shown in FIG. 1, the charging pile 10 and the vide monitoring device 20 are implemented as different devices, and the two devices may be integrated on one apparatus, for example, the charging pile 10 comprises the video monitoring device 20 or other partial functions.

In an embodiment, the parking space 44 is further provided with a wireless charging system for performing wireless charging for the electric vehicle parked at the parking space.

The smart ground locks 42 are configured to control an access state of the parking space. In FIG. 1, the smart ground locks 42 are shown in the form of electrically-driven liftable ground locks and located at the periphery of the parking space. In other embodiments, other forms of electrically-controllable ground locks may be used, for example, an erectable and flatable ground lock is located at a center of the parking lot.

FIG. 2 illustrates a function block diagram of a charging pile 10 according to an embodiment of the present disclosure. The charging pile 10 comprises a power supply input 101, a power converter 102 and a charging interface 103. The power supply input 101 is a power supply input terminal of the charging pile and used to connect with an external power grid (e.g., mains power grid). The charging interface 103 is a power output terminal of the charging pile and used to connect with the electric vehicle and charge the battery of the electric vehicle. The power converter 102 is used to convert the received power input from the external power grid into a power output for charging the electric vehicle. They are conventional modules for charging the electric vehicle. The charging pile 10 may further comprise one or more of an automatic parking means 105, a ground lock control means 106, a vehicle authentication means 109 and a wireless charging control means 108. The charging pile 10 shown in FIG. 2 further comprises a video parsing means 104 and a video collecting means 107. However, it should be appreciated that according to different specific implementation requirements, one or two of the video paring means 104 and the video collecting means 107 may be implemented through a device external of the charging pile (for example, the video monitoring device 20 as shown in FIG. 1).

The video collecting means 107 may collect images or video data within the monitoring scope, and particularly collect information of a vehicle entering the monitoring scope, and transmit the collected information to the video parsing means 104 for processing. The video parsing means 104 parses the collected video data to obtain information needed by means such as automatic parking means 105, transmits the parsed information to a corresponding means, and assists operation of the corresponding means. The automatic parking means 105 processes data parsed by the video parsing means 104, e.g., analyzes a position of the electric vehicle relative to the parking space by using an image identification and analysis algorithm, and controls wireless communication with the electric vehicle to control the vehicle to implement automatic parking. The ground lock controlling means 106 is used to control turn-on and turn-off of the ground locks 42 disposed at the periphery of the parking space to thereby control an access state of the parking space. The wireless charging means 108 is used to control the wireless charging system arranged on the parking space 44 to implement wireless charging of the electric vehicle 30 parked at the parking space. The vehicle authentication means 109 authenticates the vehicle using vehicle information such as vehicle license plate number or vehicle model and allows only those electric vehicles that meet preset conditions to be parked at the parking space 44.

It should be appreciated that the structural block diagram shown in FIG. 2 is illustrated only for an exemplary purpose, not to limit the present disclosure. The charging pile 10 may further comprise other means or modules integrated in a conventional charging pile, for example, include but not limited to a charge protection means, a metering means, a card reading means and the like.

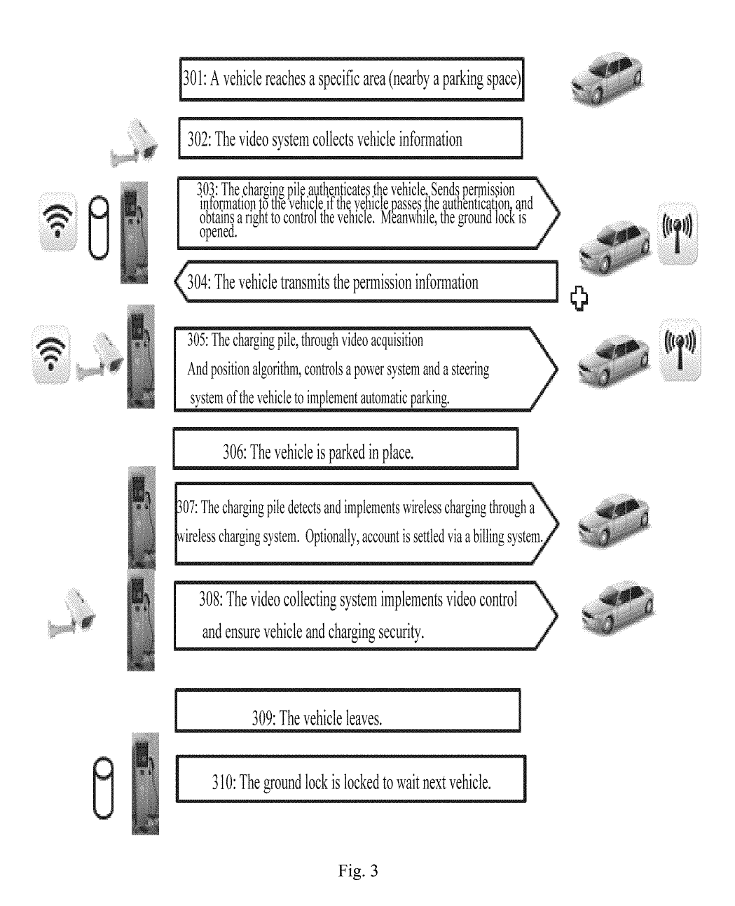

FIG. 3 illustrates a flow chart of using a charging pile 10 to control the electric vehicle 30 and implement automatic parking according to an embodiment of the present disclosure.

The video monitoring means 20 disposed external of the charging pile 10 is disposed around the parking space 44, and its monitoring scope can cover a surrounding area of the parking space 44. In step 301, the video monitoring device 20 monitors that there is an electric vehicle reaching nearby the parking space.

In step 302, the video monitoring device 302 collects images or video data within the monitoring scope, including vehicle information such as license plate number and/or vehicle model, performs parsing, and transmits the collected and parsed images or video information to the charging pile 10.

In step 303, the charging pile 10 receives collected information transmitted from the video monitoring device 20, and the vehicle authentication means 109 included by the charging pile 10 authenticates an incoming vehicle. If the vehicle passes authentication, the automatic parking means 105 transmits parking permission information to the vehicle, and sends a request to obtain a right to control the vehicle. Meanwhile, the ground lock controlling mean 106 included by the charging pile 10 communicates with the smart ground locks 42 around the parking space and controls to open the ground locks.

It should be appreciated that in step 303, the vehicle authenticating step is an optional step of the present disclosure. A specific procedure of authenticating the vehicle will be described later.

In step 304, the electric vehicle sends to the charging pile 10 a response message permitting the automatic parking means 105 to take over the vehicle.

In step 305, the automatic parking means 105 included in the charging pile 10 may, through an image processing algorithm, analyze to obtain a dynamic position of the electric vehicle relative to the parking space 44 according to the images or video information obtained in step 303, or by performing interaction with the video monitoring device 20 again (or for many times) to obtain richer information, and implement automatic parking by controlling a power system and a steering system of the electric vehicle.

According to this embodiment, the video monitoring device 20 assists the charging pile in performing automatic parking of the electric vehicle.

In step 306, the electric vehicle is parked in place under wireless control of the automatic parking means 105.

So far, there is provided a charging pile-based automatic parking technology according to image video or guidance. Conventional automatic parking measures a distance through a radar on the vehicle, and is disadvantageous in inaccurate positioning and many modification times. In contrast, in the charging pile-based automatic parking technology according to an embodiment of the present disclosure, the vehicle position information collected by video is more thorough and all-around, so parking may be completed more quickly through an algorithm.

In step 307, the wireless charge controlling means 108 included in the charging pile 10 controls the wireless charging system at the parking space to perform wireless charging for the parked electric vehicle. For example, wireless transmission of electrical energy is implemented by electromagnetic coupling technology. Optionally, account settlement is implemented via a billing system.

In step 308, the video monitoring device 20 implements monitoring for the parked vehicle and its charging procedure. The video monitoring device 20 may transmit the collected images or video to the charging pile 10. The charging pile 10 analyzes the received images, and gives an alarm upon judging that the vehicle leaves without authorization or the charging procedure is abnormal (e.g., catch fire). In this way, safety of the parked vehicle and the charging procedure is ensured. In this case, the charging pile 10 may include an extra safety monitoring means for monitoring the vehicle parked at the parking space and/or the wireless charging procedure of the vehicle.

In step 309, the parked vehicle runs away from the parking space.

In step 310, the ground lock control means 106 included in the charging pile 10 may analyze from the images or video data transmitted from the video parsing means 104 and work out that the vehicle runs away from the parking space, it communicates with the smart ground locks 42 at the periphery of the parking space to control to close the ground locks.

According to an embodiment of the present disclosure, different from implementation of the smart charging pile 10 shown in FIG. 2, the video collecting means 107 and video parsing means 104 are implemented outside the charging pile 10. The video collecting means 107 may collect images or video information via a plurality of cameras, and transmit the collected multi-view angle information to the video parsing means 104.

According to an embodiment of the present disclosure, the video parsing means 104 is configured to parse from the images information collected by the video collecting means 107 to obtain information such as a vehicle license plate number and vehicle model. The vehicle authentication means 109 is configured to use the license plate information (e.g., license plate number) and vehicle model information obtained from the parsing to authenticate a vehicle occurring nearby the parking space. The charging pile 10 may further comprise a memory for storing a license plate list or a vehicle model list of vehicles permitted to be parked and/or not permitted to be parked. The vehicle model information may comprise for example whether the vehicle is an electric vehicle, whether the vehicle is a vehicle already registered at the parking lot, whether the vehicle supports automatic parking, and whether the vehicle supports wireless charging.

According to an embodiment of the present disclosure, the video parsing means 104 is configured to assist the charging pile in performing automatic parking for the electric vehicle.

The automatic parking means 105 may perform analysis of a position of the vehicle relative to the parking space according to the images or video information transmitted from the video parsing means 104 and by means of an images processing algorithm, to find the quickest parking path.

According to an embodiment of the present disclosure, the video paring means 104 is configured to perform security monitoring of the electric vehicle and its wireless charging procedure.

According to an embodiment of the present disclosure, the wireless charging system arranged on the parking space 44 comprises a power supply resonator connected with the power supply, and it is connected via a wired cable and a charging controller laid below the parking space. The power supply resonator may perform electromagnetic energy transmission with the power supply resonator disposed on the chassis of the electric vehicle. The wireless charging means 108 included by the charging pile 10 performs wireless communication with the charging controller to control wireless charging of the vehicle.

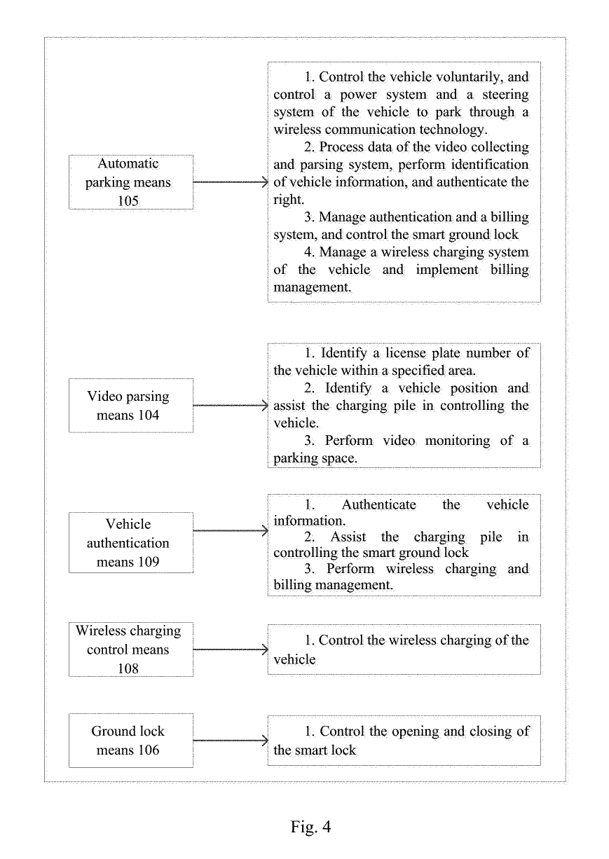

FIG. 4 illustrates a schematic view of functions implemented by units of the charging pile as shown in FIG. 2. It should be appreciated that the functions shown in FIG. 4 are only exemplary not restrictive, and all the functions included by respective units are functions that may be selected by the charging pile 10.

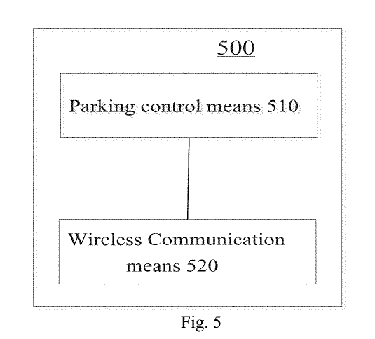

FIG. 5 illustrates a function block diagram of an electric vehicle used in cooperation with the charging pile as shown in FIG. 2 according to an embodiment of the present disclosure. According to an embodiment of the present disclosure, only a wireless communication module 520 needs to be added to the current electric vehicle 500 supporting automatic parking and is used to receive an automatic parking instruction for example transmitted from the automatic parking means 105 included by the charging pile 10, and transmit the automatic parking instruction to the current parking control means 510 of the electric vehicle, and it is used to control a power system and a steering system of the electric vehicle to implement automatic parking.

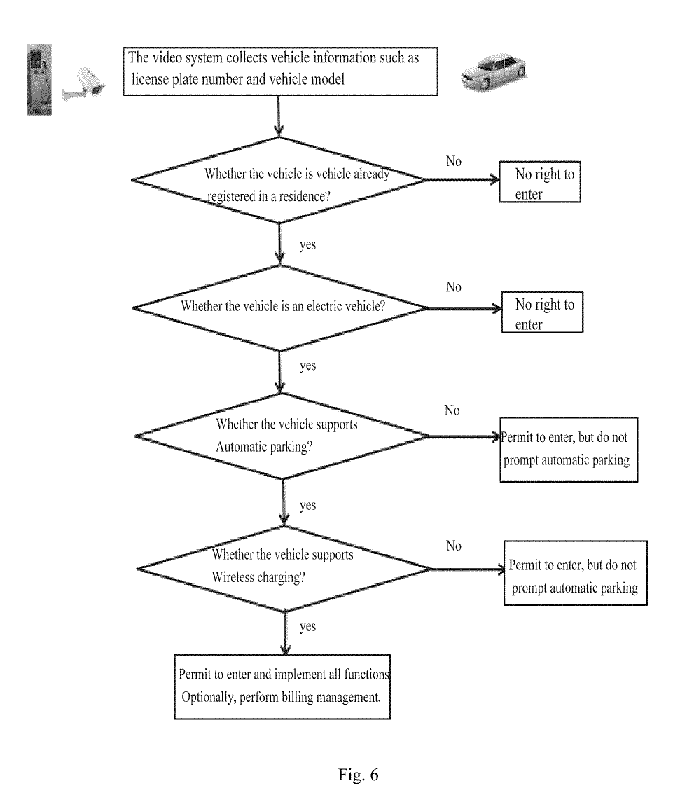

FIG. 6 illustrates a control flow chart of a charging pile authenticating an electric vehicle parked in a parking space according to an embodiment of the present disclosure. After the charging pile 10 completes authentication of the electric vehicle, the charging pile 10 controls the smart ground locks to perform the opening and closing function. In this way, use of the parking space by an unauthorized vehicle is avoided.

Authentication of the vehicle may be performed using information such as license plate number and vehicle model. The authentication conditions may include but not limited to what is shown in FIG. 6: whether the vehicle is an electric vehicle, whether the vehicle is a vehicle already registered at the parking lot, whether the vehicle supports active parking, and whether the vehicle supports wireless charging. However, it should be appreciated that these conditions are only illustrative. Meanwhile, different selections may be used under different application occasions.

According to an embodiment of the present disclosure, the electric vehicle may be wirelessly accessed to the charging pile-based smart control system. Alternatively, the vehicle needs to be authenticated when it approaches a designated area. It is optional to park the electric vehicle by automatic parking (which needs to be supported) or manual parking. In the case of automatic parking, the charging pile, guided by wireless technology and images or video, initiatively controls the vehicle to perform automatic parking. Since the charging pile located external of the parking space can collect more thorough information about the position of the vehicle relative to the parking space, quick parking might be implemented.

It should be appreciated that the aforesaid functions introduced in the charging pile 10 and electric vehicle 500 described in the text, including the automatic parking means 105, the ground lock control means 106, the wireless charging control means 108, the video parsing means 104, the vehicle authentication means 109, the parking control means 510, and the wireless communication means 520, may be implemented with software, hardware, and a combination of software and hardware. The hardware portion may be implemented by a dedicated logic; the software portion may be stored in the memory, and executed by a proper instruction execution system such as a microprocessor, a personal computer (PC) or a mainframe. In some embodiments, the present invention is implemented as software, including but not limited to firmware, resident software, microcode and the like.

It should be appreciated that the flowcharts and block diagrams in the figures illustrate a method, an apparatus, or functions and operations executable by a computer program product according to the embodiments of the present invention, wherein functions and operations indicted by dotted lines represent optional functions and operations. Each block in the block diagrams and flow charts and a combination of blocks in block diagrams and/or flow charts may be implemented by a dedicated hardware-based system for executing a prescribed function or operation or may be implemented by a combination of dedicated hardware and computer instructions. It should be noted that in some alternative implementations, functions marked in blocks may happen in an order different from the order marked in the figures. For example, two blocks consecutively presented in fact may be executed substantially in parallel, and they sometimes may be executed in opposite orders, which depends on the involved functions. For example, opening the ground locks in step 303, automatic parking in step 305, and judging sequence of the authentication conditions in FIG. 6 may be executed in an order different from that shown in the figures.

The description of the present invention has already been presented for illustrative and description purpose, but this is not intended to exhaust or limit the disclosed forms of invention. Those skilled in the art, after reading through the content of the present disclosure, may further envisage many modifications and variations. The above-described various embodiments may be used individually or used in various combinations, unless otherwise specified in the preceding text.

Therefore, embodiments are selected and described to better illustrate principles and actual application of the present disclosure and enable those skilled in the art to understand the following content, that is, all modifications and substitutions made without departing from the spirit of the present disclosure all fall within the protection scope of the present disclosure as defined by the appended claims.

1-11. (canceled)

12. A charging pile control system, comprising:
at least one video monitoring device configured to collect images or video data in a monitoring scope, parse the collected images or video data, and transmit the parsed images or video data to a multi-functional charging pile, the monitoring scope covering at least one parking space and its surrounding area; and
a multi-functional charging pile configured to receive the images or video data transmitted by the at least one video monitoring device, analyze images according to the images or video data a position of an electric vehicle entering the monitoring scope relative to an idle parking space among the at least one parking space, and control the electric vehicle to implement automatic parking.

13. The charging pile control system according to claim 12, further comprising:
at least one smart ground lock disposed in association with the at least one parking space and configured to control an access state of the at least one parking space,
wherein the multi-functional charging pile is further configured to control to open a smart ground lock in association with the idle parking space among the at least one smart ground lock when the electric vehicle is controlled to implement automatic parking.

14. The charging pile control system according to claim 12, wherein the multi-functional charging pile is further configured to authenticate the vehicle entering the monitoring scope by using information of the vehicle entering the monitoring scope parsed by the at least one video monitoring device, and wherein the controlling the electric vehicle to implement automatic parking comprises only controlling the vehicle that has already passed authentication to implement automatic parking.

15. The charging pile control system according to claim 14, wherein authenticating the vehicle entering the monitoring scope comprises using license plate number and/or vehicle model information among the parsed vehicle information to authenticate the vehicle.

16. The charging pile control system according to claim 15, wherein the using the parsed license plate number and/or vehicle model information to authenticate the vehicle comprises: identifying the vehicle in respect of one or more of the following items:
whether the vehicle is an already-registered vehicle,
whether the vehicle is an electric vehicle,
whether the vehicle supports active parking, and
whether the vehicle supports wireless charging.

17. The charging pile control system according to claim 12, wherein the at least one parking space is provided with at least one wireless charging system,
the multi-functional charging pile is further configured to control wireless charging for the electric vehicle which has implemented automatic parking.

18. A multi-functional charging pile, comprising:
an automatic parking means configured to analyze a position of an electric vehicle relative to a parking space according to acquired images or video data of the electric vehicle and parking space, and control the electric vehicle to implement automatic parking.

19. The multi-functional charging pile according to claim 18, further comprising:
a video collecting means configured to collect images or video data within a monitoring scope; and/or
a video parsing means configured to parse the images or video data collected by the video collecting means.

20. The multi-functional charging pile according to claim 19, further comprising:
a vehicle authentication means configured to authenticate the vehicle entering the monitoring scope by using information of the vehicle entering the monitoring scope parsed by the at least one video monitoring device,
wherein the controlling the electric vehicle to implement automatic parking comprises only controlling the vehicle that has already passed authentication to implement automatic parking.

21. The multi-functional charging pile according to any one of claims 18, further comprising:
a ground lock control means configured to control an access state of the parking space, and/or
a wireless charging control means configured to control wireless charging for the electric vehicle which has implemented automatic parking.

22. An electric vehicle, comprising:
a parking control means configured to control a power system and a steering system of the electric vehicle to implement automatic parking; and
a wireless communication means configured to receive an automatic parking instruction, and transmit the automatic parking instruction to the parking control means.
